(19) United States
(12) Patent Application Publication
(10) Pub. No.: US 2026/0227917 A1
(43) Pub. Date: Aug. 6, 2026

(54) TECHNIQUES FOR DYNAMICALLY CONFIGURING MEMORY IN A COMPUTING SYSTEM

(71) Applicant: NVIDIA CORPORATION, Santa Clara, CA (US)

(72) Inventors: Rangharajan VENKATESAN, San Jose, CA (US); Benjamin Andrew KELLER, Oakland, CA (US); Thierry TAMBE, Palo Alto, CA (US)

(21) Appl. No.: 19/043,355

(22) Filed: Jan. 31, 2025

(51) Int. Cl. G06F 3/06

(52) U.S. Cl. CPC G06F 3/0625; G06F 3/0634; G06F 3/0673

(57) ABSTRACT

One embodiment of a method for storing and accessing data includes receiving a request that specifies a first memory address and a memory bank cluster size, and storing data in or reading data from a memory bank included in a memory based on the first memory address and the memory bank cluster size.

### BACKGROUND

### Field of the Various Embodiments

The various embodiments relate generally to computer science and computer memory systems and, more specifically, to techniques for dynamically configuring memory in a computing system.

### Description of the Related Art

In computing systems, memory banks are organized storage units within a memory system that facilitate efficient access to data. A memory bank is typically a set of memory cells or modules grouped together to function as a single entity. The grouped memory cells can be used for various tasks, such as storing data, accessing the stored data for computational operations, and storing the output of those computational operations.

Each memory bank within a memory is typically associated with a set of addressable locations where data can be stored or retrieved. Having multiple memory banks in a computing system allows for simultaneous access to data across the multiple memory banks, increasing the overall data transfer rate and improving the speed of data storage and retrieval operations.

One approach for storing data across the different memory banks of a memory system is to store the data sequentially such that data is stored across one memory bank at time. In this approach, when the current memory bank becomes full, data continues to be stored sequentially across another memory bank. One drawback of storing data sequentially, however, is that the stored data needs to be read sequentially from one memory bank at a time as well. Reading data from one memory bank at a time can be substantially slower than reading data from multiple memory banks simultaneously.

Another approach for storing data across the different memory banks of a memory system is to store data across all of the memory banks at the same time. For example, a first value could be stored in a first memory bank, a second value could be stored in a second memory bank, until a value has been stored in the last memory bank of the memory system, after which a next value is stored in the first memory bank again, and so forth. Data that is stored across all of the memory banks can be read from those same memory bank simultaneously. One drawback of this approach, however, is that every memory bank in the memory system needs to be kept in an active state, even when the data being stored does not fill all of the different memory banks. Keeping all memory banks in the active state, as opposed to switching some of the memory banks to a reduced power state, can consume significant amounts of power.

As the foregoing illustrates, what is needed in the art are more effective techniques for storing data in and reading data from the memory banks of memory systems.

### SUMMARY

One embodiment of the present disclosure sets forth a computer-implemented method for storing and accessing data. The method includes receiving a request that specifies a first memory address and a memory bank cluster size. The method further includes storing data in or reading data from a memory bank included in a memory based on the first memory address and the memory bank cluster size.

One technical advantage of the disclosed techniques relative to the prior art is that, with the disclosed techniques, data can be stored across memory bank clusters that include multiple, but not all, of the memory banks of a memory system. Storing data across multiple memory banks in this fashion permits data to be stored and retrieved from the different memory banks within the memory bank cluster simultaneously, which can increase overall data transfer rates. In addition, with the disclosed techniques, any memory banks that are not being used to store data can be switched to a reduced power state, which can reduce overall power consumption of the memory system, including both idle power consumption and leakage power consumption. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be found by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a block diagram of a parallel processing unit included in the parallel processing subsystem of FIG. 1, according to various embodiments;

FIG. 3 is a block diagram of a general processing cluster included in the parallel processing unit of FIG. 2, according to various embodiments;

FIG. 4 illustrates a system-on-chip that can be included in the parallel processing subsystem of FIG. 1, according to various embodiments;

FIG. 5 illustrates how a neural network can be executed on the system-on-chip of FIG. 4, according to various embodiments;

FIGS. 6A-6C illustrate how the global scratchpad of FIG. 5 can be reconfigured with different memory bank clusters, according to various embodiments;

FIG. 7 illustrates an exemplar memory allocation within the global scratchpad of FIG. 5, according to various embodiments;

FIG. 8 illustrates an exemplar memory allocation within the global scratchpad of FIG. 5, according to other various embodiments;

FIG. 9 illustrates an exemplar memory allocation within the global scratchpad of FIG. 5, according to other various embodiments;

FIG. 10 illustrates an exemplar memory allocation within the global scratchpad of FIG. 5, according to other various embodiments;

FIG. 11 illustrates an exemplar memory allocation within in the global scratchpad of FIG. 5, according to other various embodiments;

FIG. 12 illustrates an exemplar memory allocation within the global scratchpad of FIG. 5, according to other various embodiments;

FIG. 13 illustrates an exemplar memory allocation within the global scratchpad of FIG. 5, according to other various embodiments;

FIG. 14 is a flow diagram of method steps for compiling source code to store and access data using memory bank clusters, according to various embodiments;

FIG. 15 is a flow diagram of method steps for executing a neural network using the system-on-chip of FIG. 4, according to various embodiments; and

FIG. 16 is a flow diagram of method steps for translating virtual addresses to physical addresses using memory bank clusters, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for dynamically configuring memory. In some embodiments, a scratchpad memory associated with an artificial intelligence (AI) accelerator can be dynamically configured to allocate memory according to memory bank cluster sizes specified in read and write requests. Memory allocations are interleaved within each bank cluster and are sequential across bank clusters. A read or write request to the scratchpad memory can include a virtual address and a bank cluster size. If the bank cluster size is equal to 1, then the scratchpad memory converts the virtual address to a physical address by (1) determining a memory bank based on the most significant bits of the virtual address, and (2) determining a local address within the memory bank based on the least significant bits of the virtual address. If the bank cluster size is greater than 1, then the scratchpad memory converts the virtual address to a physical address by (1) determining a bank cluster based on the most significant bits of the virtual address, (2) determining a memory bank within the bank cluster based on one or more least significant bits of the virtual address, and (3) determining a local address within the memory bank based on the other least significant bits of the virtual address. The scratchpad memory then reads or writes to the converted physical address. In some embodiments, activations that are input into, or output by, layers of a neural network can be written to and read from the scratchpad memory using various bank cluster sizes that are determined by a compiler based on computations performed by the layers, what component executes the computations, and/or the required precision.

The techniques for dynamically configuring memory of the present disclosure have many real-world applications. For example, the techniques can be used to dynamically configure a memory within a processor, such as a graphics processing unit (GPU). As a further example, the techniques can be used to dynamically configure a memory that is accessible by an AI accelerator or a near-memory processor.

The above examples are not in any way intended to be limiting. As persons skilled in the art will appreciate, as a general matter, the techniques for dynamically configuring memory described herein can be implemented anywhere that memory is required or useful.

### System Overview

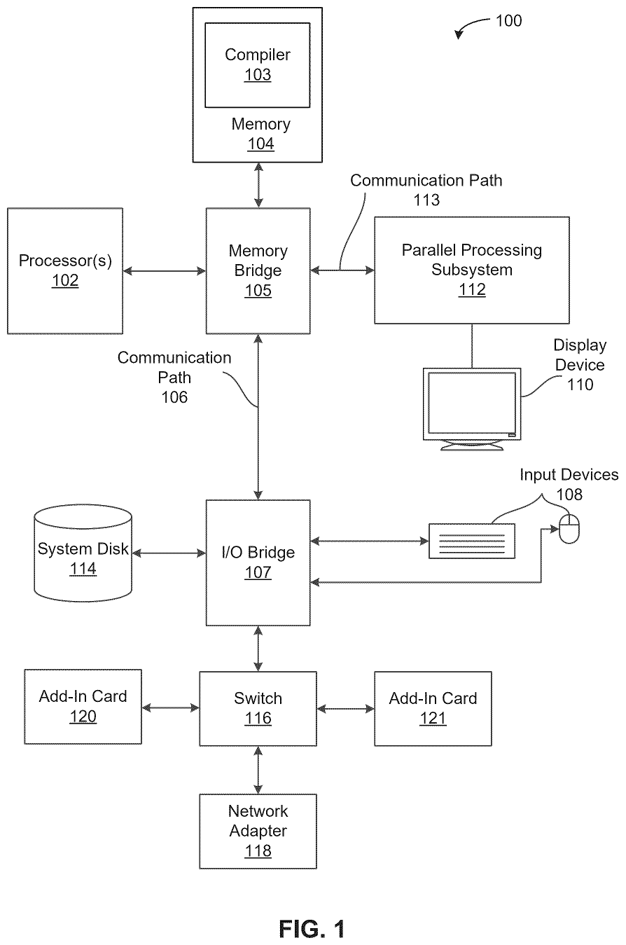

FIG. 1 is a block diagram illustrating a computer system 100 configured to implement one or more aspects of the present embodiments. As persons skilled in the art will appreciate, computer system 100 can be any type of technically feasible computer system, including, without limitation, a server machine, a server platform, a desktop machine, laptop machine, a hand-held/mobile device, or a wearable device. In some embodiments, computer system 100 is a server machine operating in a data center or a cloud computing environment that provides scalable computing resources as a service over a network.

In various embodiments, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In one embodiment, I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via network adapter 130. In one embodiment, switch 116 is configured to provide connections between I/O bridge 107 and other components of computer system 100, such as a network adapter 130 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

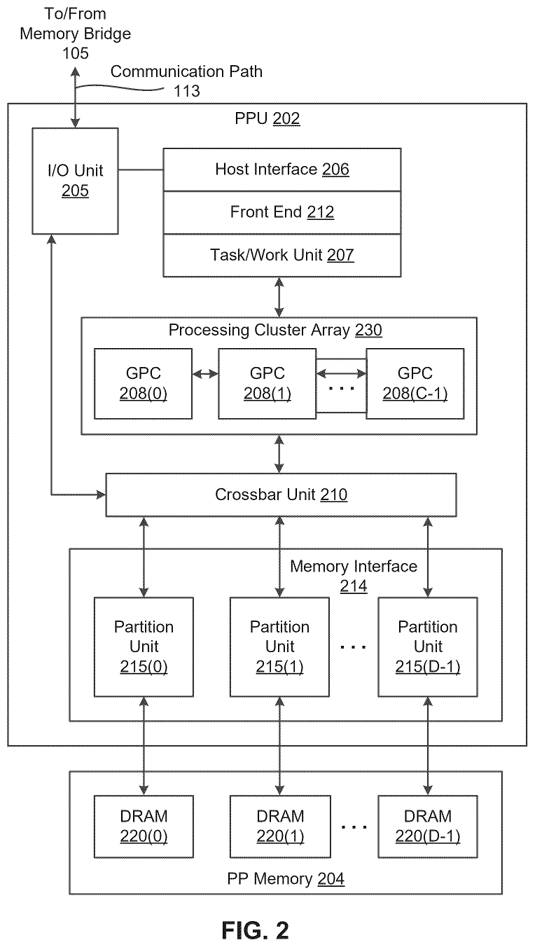

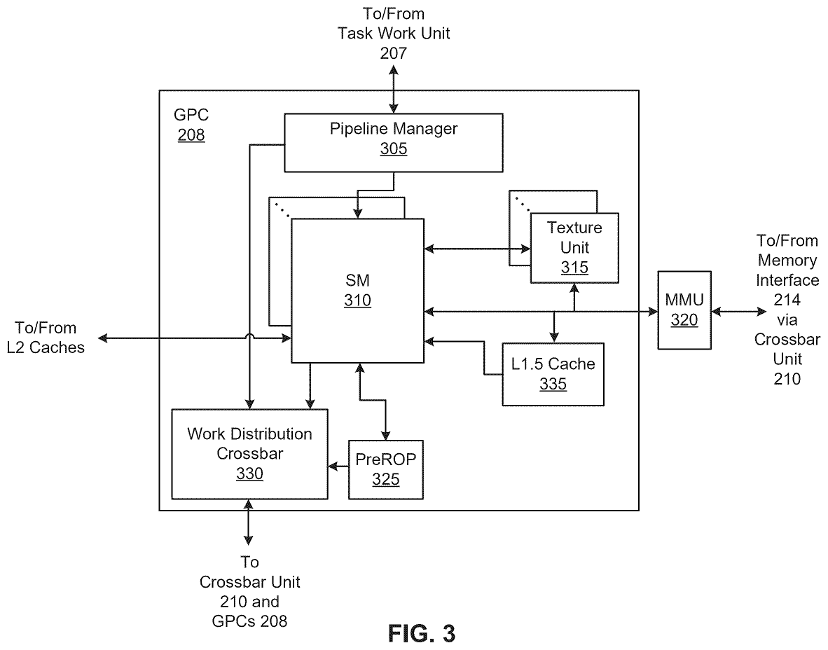

In some embodiments, parallel processing subsystem 112 comprises a graphics subsystem that delivers pixels to an optional display device 110 that may be any conventional cathode ray tube, liquid crystal display, light-emitting diode display, or the like. In such embodiments, parallel processing subsystem 112 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 112. In other embodiments, parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations.

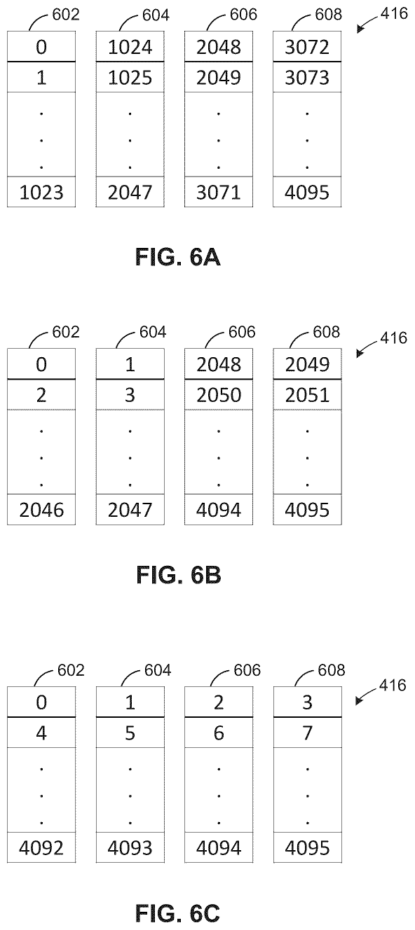

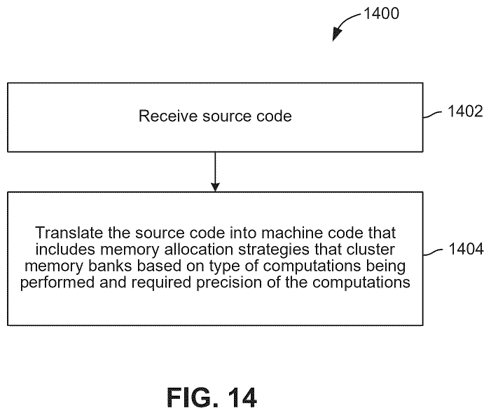

Illustratively, system memory 104 stores a compiler 103 and a runtime system 132. Compiler 103 is configured to translate source code in a human-readable programming language into machine code that can be executed by a computer. In some embodiments, compiler 103 can translate the source code for computations performed by a neural network into memory allocation strategies that involve clustering memory banks in a scratchpad memory based on the type of computations, what component executes the computations (e.g., the AI accelerator 406 and the near-memory processor 410 can have different bandwidth requirements), and/or the required precision, as discussed in greater detail below in conjunction with FIGS. 6C and 14. Although described herein primarily with respect to compiler 103 as reference examples, techniques disclosed herein can also be implemented, either entirely or in part, in other software and/or hardware, such as in parallel processing subsystem 112.

In various embodiments, parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other embodiments, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. In certain embodiments, one or more components shown in FIG. 1 may not be present. For example, switch 116 could be eliminated, and network adapter 130 and add-in cards 120, 121 would connect directly to I/O bridge 107. Lastly, in certain embodiments, one or more components shown in FIG. 1 may be implemented as virtualized resources in a virtual computing environment, such as a cloud computing environment. In particular, parallel processing subsystem 112 may be implemented as a virtualized parallel processing subsystem in some embodiments. For example, parallel processing subsystem 112 could be implemented as a virtual graphics processing unit (GPU) that renders graphics on a virtual machine (VM) executing on a server machine whose GPU and other physical resources are shared across multiple VMs.

FIG. 2 is a block diagram of a parallel processing unit (PPU) 202 included in parallel processing subsystem 112 of FIG. 1, according to various embodiments. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a GPU that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to an optional display device 110 for display. In some embodiments, PPU 202 also may be configured for general-purpose processing and compute operations. In some embodiments, computer system 100 may be a server machine in a cloud computing environment. In such embodiments, computer system 100 may not have a display device 110. Instead, computer system 100 may generate equivalent output information by transmitting commands in the form of messages over a network via network adapter 130.

In some embodiments, CPU 102 is the master processor of computer system 100, controlling and coordinating operations of other system components. In one embodiment, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a command queue, also referred to herein as a pushbuffer, to initiate processing of the stream of commands in the data structure. In one embodiment, PPU 202 reads command streams from the command queue and then executes commands asynchronously relative to the operation of CPU 102. In embodiments where multiple pushbuffers are generated, execution priorities may be specified for each pushbuffer by an application program via device driver to control scheduling of the different pushbuffers.

In one embodiment, PPU 202 includes an I/O (input/output) unit 205 that communicates with the rest of computer system 100 via communication path 113 and memory bridge 105. In one embodiment, I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. In one embodiment, host interface 206 reads each command queue and transmits the command stream stored in the command queue to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In one embodiment, front end 212 transmits processing tasks received from host interface 206 to a work distribution unit (not shown) within task/work unit 207. In one embodiment, the work distribution unit receives pointers to processing tasks that are encoded as task metadata (TMD) and stored in memory. The pointers to TMDs are included in a command stream that is stored as a command queue and received by front end unit 212 from host interface 206. Processing tasks that may be encoded as TMDs include indices associated with the data to be processed as well as state parameters and commands that define how the data is to be processed. For example, the state parameters and commands could define the program to be executed on the data. Also, for example, the TMD could specify the number and configuration of the set of CTAs. Generally, each TMD corresponds to one task. The task/work unit 207 receives tasks from front end 212 and ensures that GPCs 208 are configured to a valid state before the processing task specified by each one of the TMDs is initiated. A priority may be specified for each TMD that is used to schedule the execution of the processing task. Processing tasks also may be received from processing cluster array 230. Optionally, the TMD may include a parameter that controls whether the TMD is added to the head or the tail of a list of processing tasks (or to a list of pointers to the processing tasks), thereby providing another level of control over execution priority.

In one embodiment, PPU 202 implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

In one embodiment, memory interface 214 includes a set of D of partition units 215, where D≥1. Each partition unit 215 is coupled to one or more dynamic random access memories (DRAMs) 220 residing within PPM memory 204. In some embodiments, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

In one embodiment, a given GPC 208 may process data to be written to any of the DRAMs 220 within PP memory 204. In one embodiment, crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In some embodiments, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between GPCs 208 and partition units 215.

In one embodiment, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

In one embodiment, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, wearable devices, servers, workstations, game consoles, embedded systems, and the like.

FIG. 3 is a block diagram of a general processing cluster (GPC) 208 included in the parallel processing unit (PPU) 202 of FIG. 2, according to various embodiments. As shown, GPC 208 includes, without limitation, a pipeline manager 305, one or more texture units 315, a preROP unit 325, a work distribution crossbar 330, and an L1.5 cache 335.

In one embodiment, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment, operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In various embodiments, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, 5OR), bit-shifting, and computation of various algebraic functions (e.g., planar interpolation and trigonometric, exponential, and logarithmic functions, etc.). Advantageously, the same functional execution unit can be configured to perform different operations.

In one embodiment, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within SM 310, in which case some of the execution may be idle during cycles when that thread group is being processed. A thread group may also include more threads than the number of execution units within SM 310, in which case processing may occur over consecutive clock cycles. Since each SM 310 can support up to G thread groups concurrently, it follows that up to G*M thread groups can be executing in GPC 208 at any given time.

Additionally, in one embodiment, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within SM 310, and m is the number of thread groups simultaneously active within SM 310. In some embodiments, a single SM 310 may simultaneously support multiple CTAs, where such CTAs are at the granularity at which work is distributed to SMs 310.

In one embodiment, each SM 310 contains a level one (L1) cache or uses space in a corresponding L1 cache outside of SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, SMs 310 may beneficially share common instructions and data cached in L1.5 cache 335.

In one embodiment, each GPC 208 may have an associated memory management unit (MMU) 320 that is configured to map virtual addresses into physical addresses. In various embodiments, MMU 320 may reside either within GPC 208 or within memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In one embodiment, in graphics and compute applications, GPC 208 may be configured such that each SM 310 is coupled to a texture unit 315 for performing texture mapping operations, such as determining texture sample positions, reading texture data, and filtering texture data.

In one embodiment, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs.

### System-on-Chip for Accelerating AI Workloads

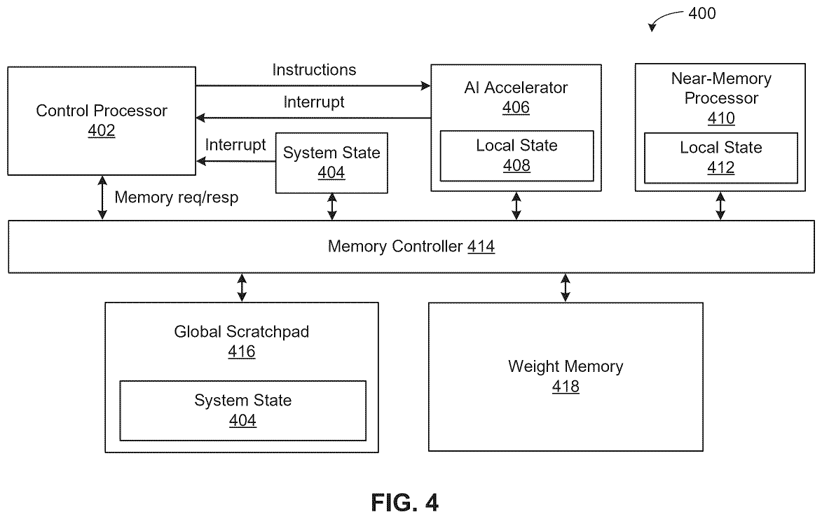

FIG. 4 illustrates a system-on-chip (SoC) 400 that can be included in the parallel processing subsystem of FIG. 1, according to various embodiments. As shown, the SoC 400 includes a control processor 402, an artificial intelligence (AI) accelerator 406, a near-memory processor 410, a memory controller 414, a global scratchpad 416, and a weight memory 418.

The AI accelerator 406 is a specialized hardware accelerator that includes circuitry for accelerating AI and machine learning applications, such as training and inferencing using artificial neural networks. Components of the AI accelerator 406 are discussed in greater detail below in conjunction with FIG. 6. Illustratively, the AI accelerator 406 maintains a local state 408 of the AI accelerator 406.

The near-memory processor 410 is a processor that improves performance of certain operations by moving the computing capability closer to the global scratchpad 416. For example, certain operations (e.g., pooling operations) do not have much re-use and can be performed by reading data from the global scratchpad 416, performing the requisite computations, and then writing the results back to the global scratchpad 416, without moving the data a further distance to the AI accelerator 406. By minimizing the movement of data, the near-memory processor 410 can reduce latency and power consumption. Illustratively, the near-memory processor 410 maintains a local state 412 of the near-memory processor 410. In some embodiments, certain memory operations that can be efficiently handled by address generators rather than the near-memory processor 410 or the AI accelerator 406.

The control processor 402 manages the flow of data and operations across components of the SoC 400. In some embodiments, the control processor 402 issues instructions that are executed by the AI accelerator 406 and the near-memory processor 410. For example, the instructions could be for the AI accelerator 406 and/or the near-memory processor 410 one or more layers of a neural network. In such cases, when the execution is completed, the AI accelerator 406 and/or the near-memory processor 418 can transmit interrupts to the control processor 402, notifying the control processor 402 that the execution is completed.

The global scratchpad 416 and the weight memory 418 are level 2 (L2) memories used to store frequently accessed data and instructions to speed up processing by reducing the need to access main memory as often. The weight memory 418 is a storage for parameters of a neural network. For example, in some embodiments, the weight memory 418 can be used to store the weights in one or more layers of a neural network. The global scratchpad 416 is a temporary storage for data during calculations involving a neural network. For example, in some embodiments, the global scratchpad 416 can store (1) input activations that are input into one or more layers of a neural network, and (2) output activations that are output by one or more layers of a neural network, for one or more layers of the neural network during training and/or inference operations. Illustratively, the global scratchpad 416 also stores a system state 404 of the SoC 400.

The memory controller 414 manages data flow between the processors, including the control processor 402, the AI accelerator 406, and the near-memory processor 401 and the memory, including the global scratchpad 416 and the weight memory 418.

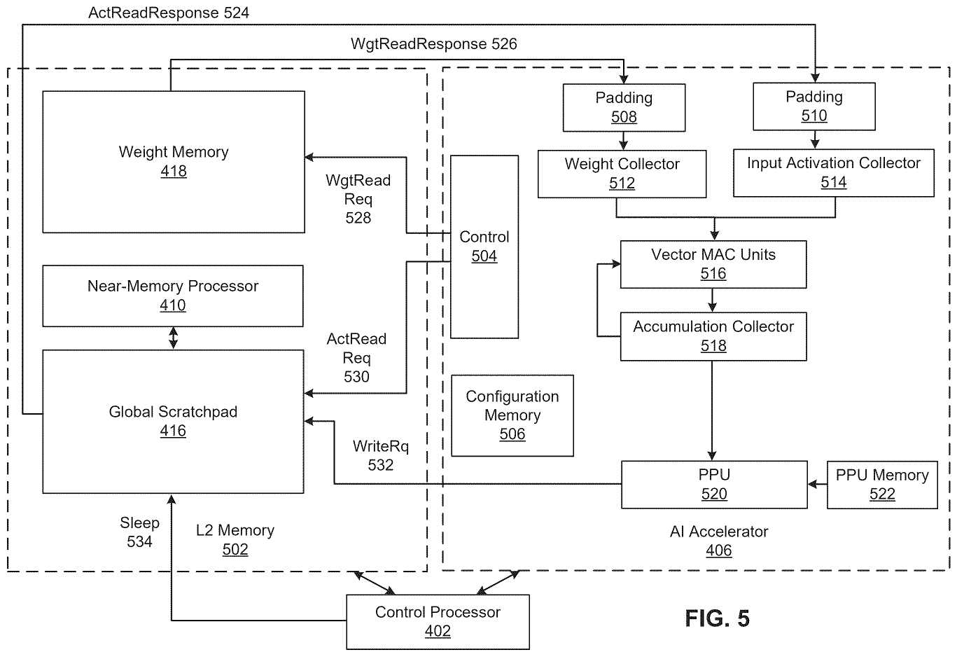

FIG. 5 illustrates how a neural network can be executed on the SoC 400 of FIG. 4, according to various embodiments. As shown, the AI accelerator 406 includes control logic 504, a configuration memory 506, padding units 508 and 510, a weight collector 512, an input activation collector 514, vector multiply-accumulate (MAC) units 516, an accumulation collector 518, a post-processing unit (PPU) 520, and a PPU memory 522.

As described, the control processor 402 manages the flow of data and operations across components of the SoC 400 by issuing instructions that are executed by the AI accelerator 406 and the near-memory processor 410. For example, the control processor 402 could issue instructions for the AI accelerator 406 to execute one or more layers of a neural network, such as a batch of back-to-back layers of the neural network, and then return control to the control processor 402. In such a case, the instructions can be stored in the configuration memory 506. In addition, the control processor 402 can control the sleep states of memory banks within the global scratchpad 416 and the weight memory 418. In some embodiments, the control processor 402 activates only the memory bank(s) storing data that is required to execute the one or more layers of the neural network, thereby switching such memory bank(s) to an “active state,” while maintaining the remaining memory bank(s) in other states that consume less leakage power. For example, memory banks storing data that needs to be used in the future could be switched to a “retention” state that consumes less leakage power than the “active” state, while memory banks that do not store any data related to the neural network can be switched to an “idle” state that consumes less leakage power than the “active” state and the “retention” state. In some embodiments, the control processor 402 can issue commands to the global scratchpad 416 and the weight memory 418 to switch the states of memory banks therein.

The control logic 504 includes circuitry that reads instructions from the configuration memory 506 and causes the instructions to be executed by the AI accelerator 406 and/or the near-memory processor 410. Illustratively, after reading instructions from the configuration memory 506 to execute one or more layers of a neural network, the control logic 504 transmits (1) requests to read input activations, shown as activation read request 530, to the global scratchpad 416, and (2) requests to read weights for the layer(s) of the neural network, shown as weight read request 528, to the weight memory 418. In response to such requests, the global scratchpad 416 returns activation read responses, shown as activation read response 524, to the AI accelerator 406, and the weight memory 418 returns weight read responses, shown as weight read response 526, to the AI accelerator 406.

Padding units 508 and 510 include circuitry configured to add padding to the activations in the activation read response 524 and the weights in the weight read response 526, respectively. In some embodiments, the padding includes zeros that are added when the vector MAC units 516 require inputs of a particular length, but the activations and/or weights have a different length. For example, when the vector MAC units 516 require vectors of length 32 as input, but the activations have a length of 8, then the padding unit 510 could pad each activation with 24 zeroes. As another example, when the vector MAC units 516 require images of a particular size as input, but the activations include smaller images, then the padding unit 510 could pad borders of the smaller images with zeroes. Another example is a convolution operation with 3×3 kernels, where the computation requires adding zeros along the border, which is independent of the size/length of the vector MAC units 516. Padding eliminates the need to store the zeroes explicitly in memory, which can save memory space.

The weight collector 512 is a memory that stores weights after any necessary padding has been added to weights in the weight response 526 by the padding unit 508. The input activation collector 514 is a memory that stores input activations after any necessary padding has been added to activations in the activation read response 524.

The vector MAC units 516 are specialized hardware that include circuitry for performing multiply-accumulate operations on multiple data elements simultaneously, allowing for faster processing of large datasets according to the Single Instruction, Multiple Data (SIMD) paradigm. In particular, the vector MAC units 516 can perform multiply-accumulate operations using the weights and input activations with (optional) padding that is stored in the weight collector 512 and the input activation collector 514, respectively. For example, the multiply-accumulate operations could involve multiplying weights by input activations, dynamically generating weights and activations, and/or the like.

The accumulation collector 518 gathers intermediate calculation results from the vector MAC units 516 and accumulates the intermediate results together. In some embodiments, accumulating the intermediate results can include summing the intermediate results.

The PPU 520 performs post processing of the accumulated output. Any technically feasible post processing operations can be performed in some embodiments. In some embodiments, the post processing can include data format conversion operations and/or non-linear operations. For example, accumulated output that is 32 bits could be converted to 4 or 8 bits to save memory space. As another example, non-linear operations, such as tanh or sigmoid operations, could be performed on the accumulated output. The PPU memory 522 is a memory coupled to the PPU 520.

In operation, to execute a layer of a neural network, (1) weights of the layer and input activations are streamed from the weight memory 418 and the global scratchpad 416, respectively, into the AI accelerator 406; (2) the padding units 510 and 508 add any necessary padding to the input activations and the weights, respectively, after which the results are stored in the input activation collector 514 and the weight collector 512, respectively; (3) the vector MAC units 516 performs multiply-accumulate operations using the stored input activations and weights with (optional) padding that are stored in the input activation collector 514 and the weight collector 512, respectively, to generate intermediate results; (4) the accumulation collector 518 gathers the intermediate calculation results from the vector MAC units 516 and accumulates the intermediate results together; (5) the PPU 520 performs post processing on the accumulated output of the accumulation collector 518; and (5) output of the PPU 512 can be written back to the global scratchpad 416 as output activations, as described above. The foregoing steps can be repeated to execute multiple layers of a neural network.

When one or more layers are to be executed by the near-memory processor 410, the control processor 402 can similarly configure the near-memory processor 410 to execute the layers sequentially. As described, the near-memory processor 410 is a processor that improves performance of certain operations by moving the computing capability closer to the global scratchpad 416. For example, certain operations do not have much re-use and can be performed by reading data from the global scratchpad 416, performing the requisite computations, and then writing the results back to the global scratchpad 416, without moving the data a further distance to the AI accelerator 406.

### Dynamically Reconfigurable Memory

FIGS. 6A-6C illustrate how the global scratchpad 416 of FIG. 5 can be reconfigured with different memory bank clusters (also referred to herein as “bank clusters”), according to various embodiments. Although described herein primarily with respect to the global scratchpad 416 as a reference example, techniques disclosed herein for dynamically reconfiguring memories with memory bank clusters can be used with any suitable memory (e.g., weight memory 418) in some embodiments, including other types of memories that are included in processors or distinct from processors. FIG. 6A illustrates four exemplar memory banks 602, 604, 606, and 608 of the global scratchpad 416 being clustered with a bank cluster size of 1. As shown, when the bank cluster size is equal to 1, each memory bank 602, 604, 606, and 608 belongs to a different cluster. In some embodiments, memory allocations are interleaved within each memory bank cluster and are sequential across memory bank clusters. When the bank cluster size is equal to 1, memory is allocated sequentially beginning with the memory bank 602 and continuing to each of the other memory banks 604, 606, and 608. Illustratively, a first set of values 0, 1, . . . , 1023 are stored sequentially in memory bank 602; values 1024, 1025, . . . , 2047 are stored sequentially in memory bank 604; values 2048, 2049, . . . , 3071 are stored sequentially in memory bank 606; and values 3072, 3073, . . . , 4095 are stored sequentially in memory bank 608.

FIG. 6B illustrates the memory banks 602, 604, 606, and 608 being clustered with a bank cluster size of 2. As shown, when the bank cluster size is equal to 2, memory banks 602 and 604 belong to a first cluster, and memory banks 606 and 608 belong to a second cluster. As described, memory allocations are interleaved within each bank cluster and are sequential across bank clusters in some embodiments. When the bank cluster size is equal to 2, memory allocations are interleaved within the first bank cluster that includes memory banks 602 and 604, as well as within the second bank cluster that includes memory banks 608 and 608. Across the first and second bank clusters, memory is allocated sequentially. Illustratively, a first value 0 is stored in memory bank 602, a second value 1 is stored in memory bank 604, a third value 2 is stored in memory bank 602, etc., until value 2047 is stored memory bank 604. Then, value 2048 is stored in memory bank 606, value 2049 is stored in memory bank 608, value 2050 is stored in memory bank 606, etc., until value 4095 is stored in memory bank 608.

FIG. 6C illustrates the memory banks 602, 604, 606, and 608 being clustered with a bank cluster size of 4. As shown, when the bank cluster size is equal to 4, memory banks 602, 604, 606, and 608 belong to the same cluster. As described, memory allocations are interleaved within each bank cluster and are sequential across bank clusters in some embodiments. When the bank cluster size is equal to 4, memory allocations are interleaved within the bank cluster that includes memory banks 602, 604, 606, and 608. Illustratively, a first value 0 is stored in memory bank 602, a second value 1 is stored in memory bank 604, a third value 2 is stored in memory bank 606, a fourth value 3 is stored in memory bank 608, a fifth value 4 is stored in memory bank 602, etc., until value 4095 is stored in memory bank 608.

In some embodiments, the global scratchpad 416 can be dynamically configured at runtime to allocate memory according to memory bank cluster sizes specified in read and write requests. That is, the global scratchpad 416 can be configured at runtime to support different addressing modes by clustering varying numbers of physical memory banks into bank clusters, which are essentially virtual memory banks. Doing so enables data to be interleaved across memory banks to provide sufficient bandwidth to keep compute units, such as the AI accelerator 406 and the near-memory processor 410, active while simultaneously enabling other memory banks to be set to sleep/retention states in order to reduce power consumption.

In some embodiments, to enable memory bank clustering, logic of a finite state machine (FSM) that is implemented using circuitry at an input into the global scratchpad 416 can translate virtual memory addresses to physical memory addresses according to Algorithm 1 before the physical memory address is accessed. Although described herein primarily with respect to logic for translating virtual memory addresses to physical memory addresses being included in the global scratchpad 416 at an input of the global scratchpad as a reference example, in some embodiments, the logic for virtual memory addresses to physical memory addresses can be distinct from the global scratchpad 416. For example, in some embodiments, circuitry that is separate from the global scratchpad 416 can include logic for translating virtual memory addresses to physical memory addresses, and the physical memory addresses can then be transmitted to the global scratchpad 416 to access the physical address.

### Algorithm 1

Inputs: virtual_addr, bank_cluster_size
Outputs: physical_bank_addr, physical_local_addr
   switch(bank_cluster_size) {
      case 1:
         physical_bank_addr=virtual_addr[AddrWidth-1:LocalAddrWidth]
         physical_local_addr=virtual_addr[LocalAddrWidth-1:0]
      case 2:
         physical_bank_addr[0]=virtual_addr[0]
         physical_bank_addr[BankAddrWidth-1:1]=virtual_addr[AddrWidth 1:LocalAddrWidth+1]
         physical_local_addr=virtual_addr[LocalAddrWidth:1]
      case 4:
         physical_bank_addr[1:0]=virtual_addr[1:0]
         physical_bank_addr[BankAddrWidth-1:2]=
         virtual_addr[AddrWidth-1:LocalAddrWidth+2]
         physical_local_addr=virtual_addr[LocalAddrWidth+1:2]
   }
}

According to Algorithm 1, given as inputs a virtual address and a bank cluster size, the global scratchpad 416 determines whether the bank cluster size is 1, 2, or 4. Although bank cluster sizes of 1, 2, and 4 are shown as an illustrative example, any bank cluster sizes can be used in some embodiments. If the bank cluster size is equal to 1, the global scratchpad 416 determines (1) a memory bank (physical_bank_addr) based on the most significant bits of the virtual address, and (2) a local address (physical_local_addr) within that memory bank based on the least significant bits of the virtual address. On the other hand, if the bank cluster size is greater than 1, then the global scratchpad 416 can (1) determine a bank cluster based on the most significant bits of the virtual address, (2) determine a memory bank within the bank cluster based on one or more least significant bits of the virtual address, and (3) determine a local address within the memory bank based on the other least significant bits of the virtual address. Illustratively, if the bank cluster size is 2, then the global scratchpad 416 (1) determines a bank cluster based on the most significant bits of the virtual address, (2) determines a memory bank within the bank cluster based on a first least significant bit of the virtual address, and (3) determines a local address within the memory bank based on the other least significant bits of the virtual address. In addition, if the bank cluster size is 4, then the global scratchpad 416 (1) determines a bank cluster based on the most significant bits of the virtual address, (2) determines a memory bank within the bank cluster based on the first two least significant bits of the virtual address, and (3) determines a local address within the memory bank based on the other least significant bits of the virtual address.

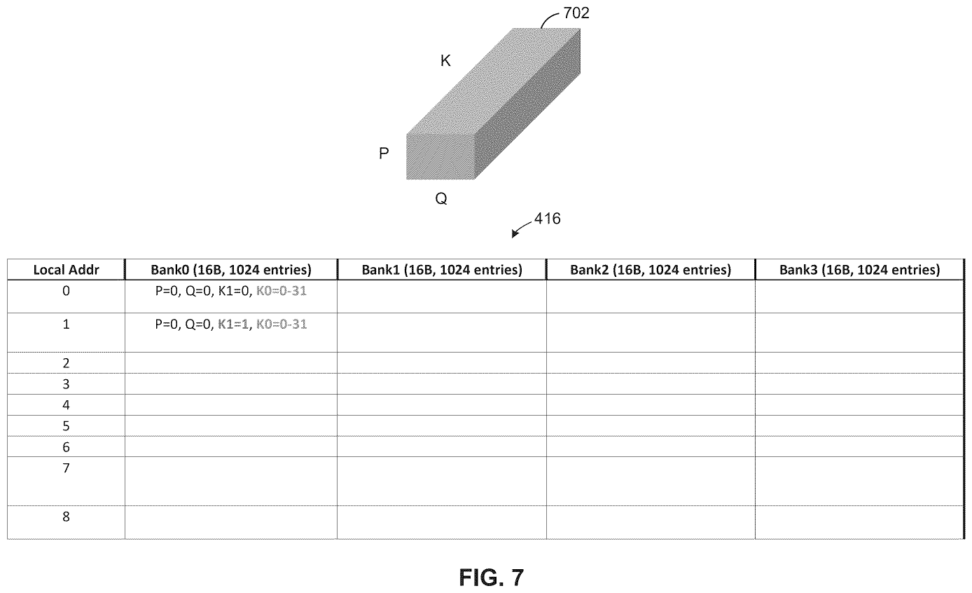

FIG. 7 illustrates an exemplar memory allocation within the global scratchpad 416 of FIG. 5, according to various embodiments. As shown, when the global scratchpad 416 includes four memory banks Bank0, Bank1, Bank2, and Bank3, and each memory bank includes entries that are 16 B wide, the memory allocation for 4 b output activations can be as follows. Output activations in the 4 b data format can be stored in one memory bank, shown as Bank0. In such a case, the bank cluster size can be set to 1. More generally, in some embodiments, a bank cluster size of 1 can be used when the bandwidth requirement is relatively low, in which case data can be written to and read from a single active memory bank at a time, thereby reducing leakage power. By contrast, a bank cluster size of >1 can be used when the bandwidth requirement is higher. The selected bank cluster size can be set dynamically at runtime in order to achieve a desired latency versus power consumption (e.g., due to the tradeoff between bandwidth and leakage power) based on the workload, as discussed in greater detail below in conjunction with FIGS. 14-16.

As shown, a tensor 702 for the output activations having dimensions P, Q, and K can be stored in memory bank Bank0. For example, the tensor 702 could be a three-dimensional (3D) tensor representing the x-and y-dimensions of an image, as well as a number of different channels, and a convolution could be performed on the tensor 702. When possible, memory is allocated in the global scratchpad 416 with vector granularity for the tensor 702. As the output activations have 4b precision, and a vector size of 32 is being used, each entry in memory bank Bank0 can store a vector of size 32 from the tensor 702. Illustratively, local address 0 of memory bank Bank0 stores the P=0, Q=0, K1=0, and K0=0-31 values from the tensor 702; local address 1 of memory bank Bank0 stores the P=0, Q=0, K1=1, and K0=0-31 values from the tensor 702; etc. After memory bank Bank0 is filled, the memory allocation continues to memory bank Bank1, and so forth. This example assumes (1) the tensor 702 is reshaped from PQK to P, Q, K1, K0, with K0=32; (2) there are 32 output lanes from the AI accelerator 406, with 32*4 b =16 B representing the width of the memory banks; and (3) the storage order is K0 (vector lanes) →K1→Q→P, so that vector lanes from the K dimension are stored first, followed by the Q dimension and then the P dimension.

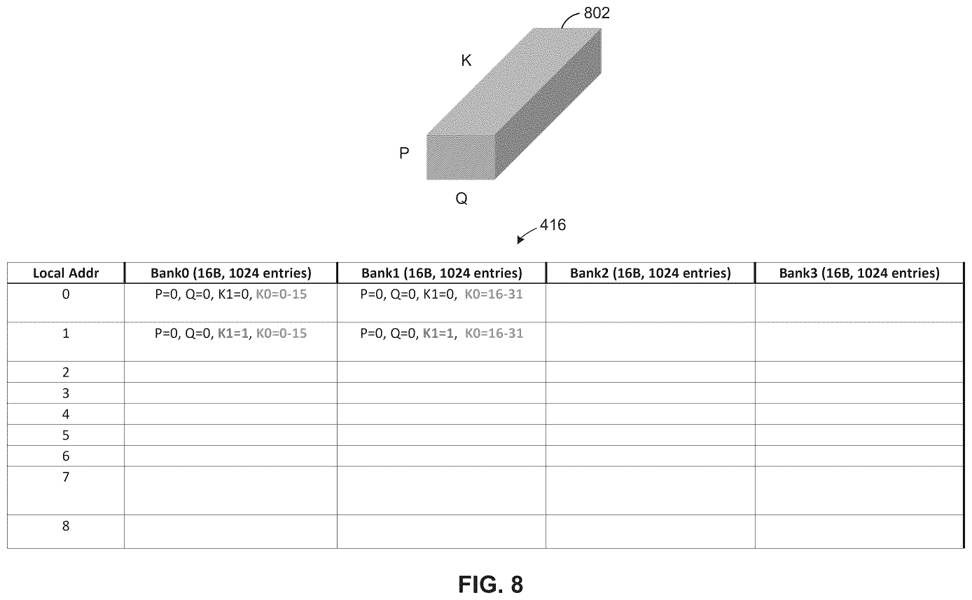

FIG. 8 illustrates another exemplar memory allocation within the global scratchpad 416 of FIG. 5, according to other various embodiments. As shown, when the global scratchpad 416 includes four memory banks Bank0, Bank1, Bank2, and Bank3, and each memory bank includes entries that are 16 B wide, the memory allocation for 8 b output activations can be as follows when the AI accelerator 406 outputs 32 lanes. Output activations in the 8 b data format can be stored across two memory banks, shown as Bank0 and Bank1. In such a case, the bank cluster size can be set to 2.

As shown, a tensor 802 for the output activations having dimensions P, Q, and K, which is similar to the tensor 702, described above in conjunction with FIG. 7, can be stored across memory banks Bank0 and Bank1. As each of the values is 8 bits, and 32 values are output by the AI accelerator 406 at a time, 16 of the 32 values can be stored in each of memory bank Bank0 and memory bank Bank1. Illustratively, local address 0 of memory bank Bank0 stores the first 16 values P=0, Q=0, K1=0, and K0=0-15 from the tensor 802; local address 0 of memory bank Bank1 stores the next 16 values P=0, Q=0, K1=0, and K0=16-31 from the tensor 804; local address 1 of memory bank Bank0 stores another 16 values P=0, Q=0, K1=1, and K0=0-15 from the tensor 802; local address 1 of memory bank Bank1 stores the next 16 values P=0, Q=0, K1=1, and K0=16-31 from the tensor 802; etc. This example assumes (1) the tensor 702 is reshaped from PQK to P, Q, K1, K0 (K0=32 vector lanes); and (2) the storage order is K0 (vector lanes)→K1→Q→P, so that vector lanes from the K dimension are stored first, followed by the Q dimension and then the P dimension. Stored output activation across two memory banks can be read as input activations for the next layer of a neural network using an input bank cluster size of 2. Although described herein primarily with respect to the AI accelerator 406 as a reference example, the near-memory processor 410 can also read input activations from multiple memory banks (e.g., two memory banks assuming the near-memory processor 410 reads 32 values) at a time and store output activations to multiple memory banks (e.g., two memory banks assuming the near-memory processor 410 writes 32 values) at a time.

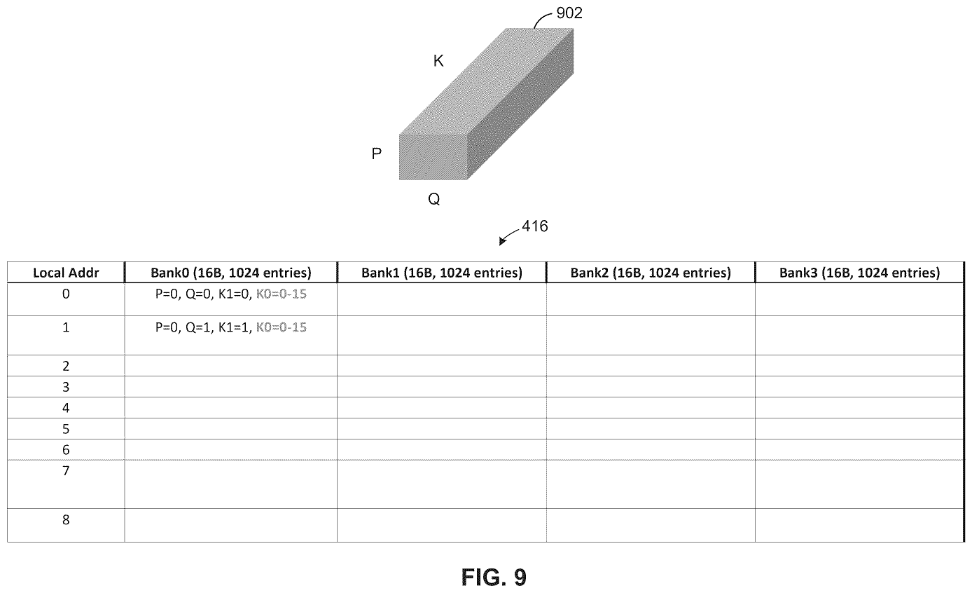

FIG. 9 illustrates another exemplar memory allocation within the global scratchpad 416 of FIG. 5, according to other various embodiments. As shown, when the global scratchpad 416 includes four memory banks Bank0, Bank1, Bank2, and Bank3, and each memory bank includes entries that are 16 B wide, the memory allocation for 8 b output activations can be as follows when the AI accelerator outputs small channels having 16 lanes. Output activations in the 8 b data format can be stored in one memory bank, shown as Bank0. In such a case, the bank cluster size can be set to 1.

As shown, a tensor 902 for the output activations having dimensions P, Q, and K, which is similar to the tensor 702, described above in conjunction with FIG. 7, can be stored in memory bank Bank0. As described, each entry of memory bank B0 is 16 B wide, so 16 lanes can be stored in a single bank. Unused lanes can be gated in the AI accelerator 406. Illustratively, local address 0 of memory bank Bank0 stores the P=0, Q=0, K1=0, and K0=0-15 values from the tensor 902; local address 1 of memory bank Bank0 stores the P=0, Q=0, K1=1, and K0=0-15 values from the tensor 902; etc. This example assumes (1) the tensor 902 is reshaped from PQK to P, Q, K1, K0 (K1=1, K0=16); and (2) the storage order is K0→K1→Q→P, so that vector lanes from the K dimension are stored first, followed by the Q dimension and then the P dimension. Stored output activation in the single memory bank Bank0 can be read as input activations for the next layer of a neural network using an input bank cluster size of 1. By storing and reading from a single memory bank, using a bank cluster size of 1, memory space can be saved in the other memory banks.

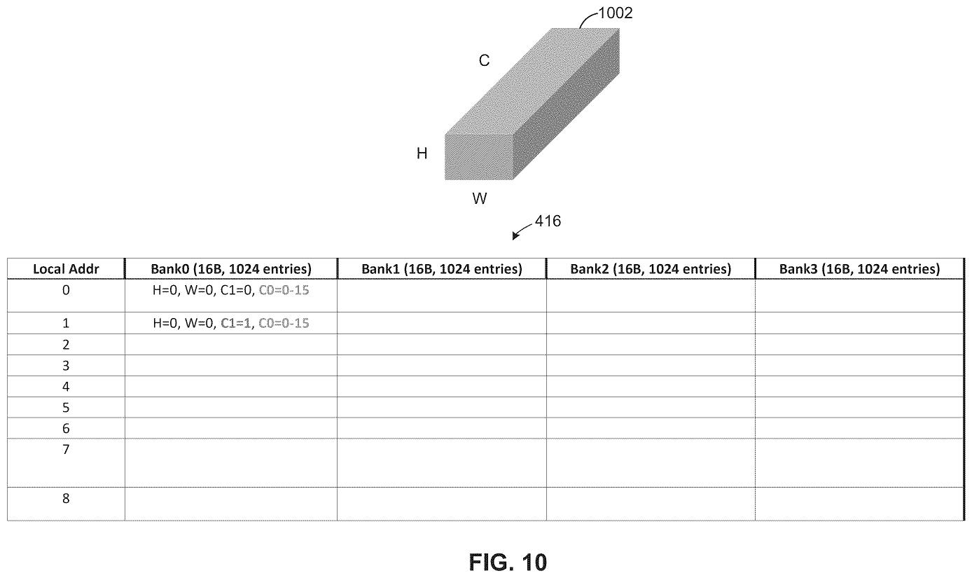

FIG. 10 illustrates another exemplar memory allocation within the global scratchpad 416 of FIG. 5, according to other various embodiments. As shown, when the global scratchpad 416 includes four memory banks Bank0, Bank1, Bank2, and Bank3, and each memory bank includes entries that are 16 B wide, the memory allocation for 8 b input activations can be as follows when the input activations are stored as 16-wide vectors. Similar to the output activations described above in conjunction with FIG. 9, input activations in the 8 b data format can be stored in one memory bank, shown as Bank0, and read from memory bank Bank0 as 16-wide vectors. In such a case, the bank cluster size can be set to 1.

As shown, a tensor 1002 for the input activations having dimensions H, W, and C can be stored in memory bank Bank0. As described, each entry of memory bank B0 is 16 B wide, so 16-wide vectors can be stored in and read from a single bank, with the input bank cluster size equal to 1. Illustratively, local address 0 of memory bank Bank0 stores the H=0, W=0, C1=0, and C0=0-15 values from the tensor 1002; local address 1 of memory bank Bank0 stores the H=0, W=0, C1=1, and C0=0-15 values from the tensor 1002; etc. This example assumes (1) the tensor 1002 is reshaped from HWC to H, W, C1, C0 (C0=16-wide vector); and (2) the storage order is C0→C1→W→H, so that vector lanes from the C dimension are stored first, followed by the W dimension and then the H dimension. Stored output activations in the single memory bank Bank0 can be read as input activations for the next layer of a neural network using an input bank cluster size of 1. If C<16, padding can be used to enable packing multiple vectors into a single entry. For example, C=4 could be stored as vectors per entry. The schedule should ensure that W0C0 is a multiple of 16

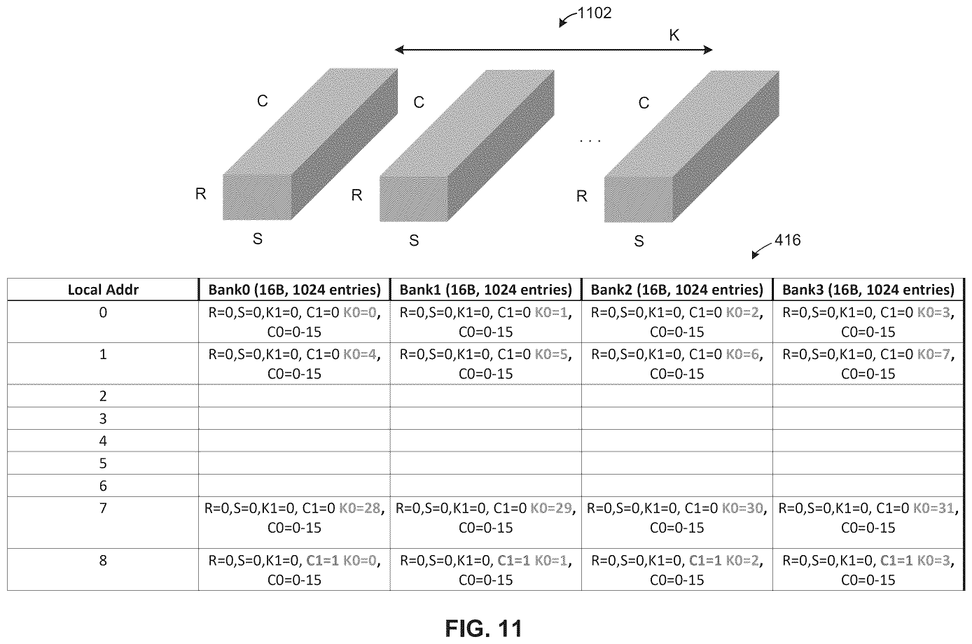

FIG. 11 illustrates another exemplar memory allocation within the global scratchpad 416 of FIG. 5, according to other various embodiments. As shown, when the global scratchpad 416 includes four memory banks Bank0, Bank1, Bank2, and Bank3, and each memory bank includes entries that are 16 B wide, the memory allocation for 8 b inputs that are weights or activations (e.g., a batch matrix multiplication layer) can be as follows when the inputs are read as 64 B blocks from four adjacent memory banks. Illustratively, the inputs in the 8 b data format are stored across the four memory Bank0, Bank1, Bank2, and Bank3. In such a case, the bank cluster size can be set to 4.

As shown, tensors 1102 for input activations having dimensions R, S, K, and C are stored across four memory banks Bank0, Bank1, Bank2, and Bank3. As described, the input activations can be read as 64 B blocks from four adjacent memory banks. For example, the input activations could be for a convolution operation, and the different inputs that include both activations and weights can be stored in the global scratchpad 416 and have different constraints. In such a case, C can be the input channel, K, can be the output channel, and R and S can be kernel dimensions. In addition, for activations, R and S can be set to 1. Illustratively, local address 0 of memory bank Bank0 stores the R=0, S=0, K1=0, C1=0, K0=0, and C0=0-15 values from the tensors 1102; local address 0 of memory bank Bank1 stores the R=0, S=0, K1=0, C1=0, K0=1, and C0=0-15 values from the tensors 1102; local address 0 of memory bank Bank2 stores the R=0, S=0, K1=0, C1=0, K0=2, and C0=0-15 values from the tensors 1102; local address 0 of memory bank Bank3 stores the R=0, S=0, K1=0, C1=0, K0=3, and C0=0-15 values from the tensors 1102; etc. This example assumes (1) the tensors 1002 are reshaped from RSKC to R, S, K1, C1, K0, C0 (K0=32 vector lanes, C0=16 vector size); and (2) the storage order is C0 (one vector)→K0 (vector lanes)→C1→K1→S→R.

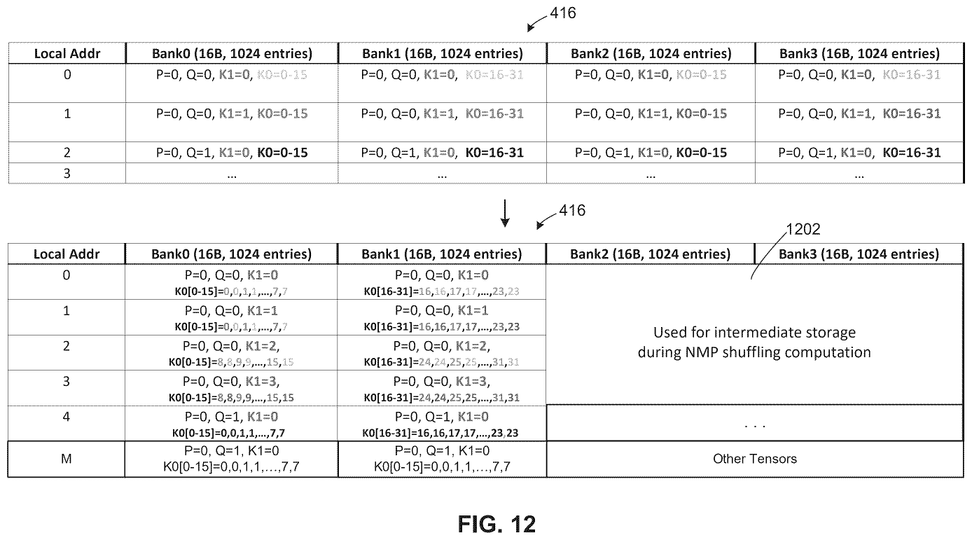

FIG. 12 illustrates another exemplar memory allocation within the global scratchpad 416 of FIG. 5, according to other various embodiments. As shown, when the global scratchpad 416 includes four memory banks Bank0, Bank1, Bank2, and Bank3, and each memory bank includes entries that are 16B wide, the memory allocation for a shuffle operation performed by the near-memory processor 410 can be as follows. Initially a first input tensor (not shown) having dimensions P, Q, and K can be stored across memory banks Bank0 and Bank1, and a second input tensor (not shown) having dimensions P, Q, and K, can be stored across memory banks Bank2 and Bank3. In such a case, the bank cluster size can be set to 2 for both the first input tensor and the second input tensor. The storage of the first and second input tensors is similar to the storage of the output activations across two memory banks, described above in conjunction with FIG. 8, except the first and second input tensors are stored across memory banks Bank0 and Bank1 and memory banks Bank2 and Bank3, respectively. The shuffle operation can involve the near-memory processor 410 (1) reading the first and second input tensors, and (2) storing the first and second input tensors in an interleaved manner to generate a shuffled output tensor. Illustratively, the shuffled output tensor is stored across memory banks Bank0 and Bank1, with a bank cluster size equal to 2. For example, in some embodiments, the interleaving can be performed across the channel dimension, which is shown as the K0[0-15], K0[16-31], etc. of the shuffled output tensor including interleaved values from the first and second input tensors. In addition, the shuffle operation can utilize an intermediate storage, shown as intermediate storage 1202.

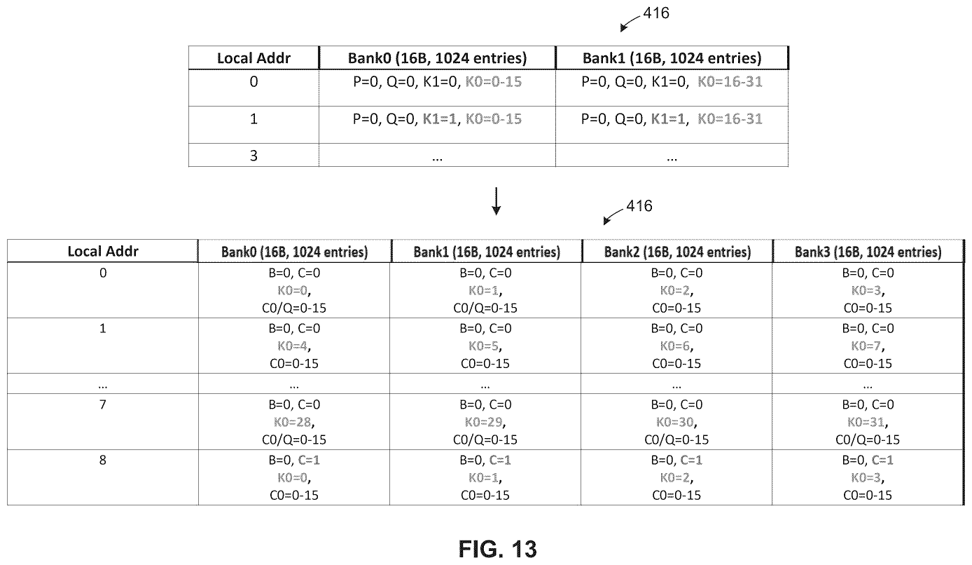

FIG. 13 illustrates another exemplar memory allocation within the global scratchpad 416 of FIG. 5, according to other various embodiments. As shown, when the global scratchpad 416 includes memory banks Bank0 and Bank1, and each memory bank includes entries that are 16 B wide, the memory allocation for a transpose operation can be as follows. Illustratively, an input tensor (not shown) having dimensions P, Q, and K can be stored across two memory banks Bank0 and Bank1 using a bank cluster size of 2, and the input tensor can be transposed to an output tensor stored using four memory banks using a bank cluster size of 4. In particular, the transpose can change P→Q→K to B→K→C across four memory banks, shown as Bank0, Bank1, Bank2, and Bank3, where C is a vector index along the Q dimension and iterates up to 16, and K is a vector lane index and iterates up to 32.

FIG. 14 is a flow diagram of method steps for compiling source code to store and access data using memory bank clusters, according to various embodiments. Although the method steps are described in conjunction with FIGS. 1-5, persons skilled in the art will understand that any system configured to perform the method steps, in any order, falls within the scope of the present disclosure.

As shown, a method 1400 begins at step 1402, where the compiler 103 receives source code. As described, the compiler 103 is configured to translate source code in a human-readable programming language into machine code that can be executed by a computer. In some embodiments, the source code received by the compiler 103 can include code for executing a neural network, during training of the neural network and/or during inference after the neural network has been trained.

At step 1404, the compiler 103 translates the source code into machine code that includes memory allocation strategies that cluster memory banks in the global scratchpad 416 based on the type of computations being performed, such as various computations by the layers of a neural network, what components executes the computations (e.g., the AI accelerator 406 and the near-memory processor 410 can have different bandwidth requirements), and/or the required precision of the computations. Depending on the required precision, different numbers of vector bits can be selected to maximize throughput, examples of which are described above in conjunction with FIGS. 7-13. For example, in some embodiments, a bank cluster size of 1 can be used when the bandwidth requirement is relatively low, in which case data can be written to and read from a single active memory bank at a time, thereby reducing leakage power. By contrast, a bank cluster size of 2 or 4 can be used when the bandwidth requirement is higher.

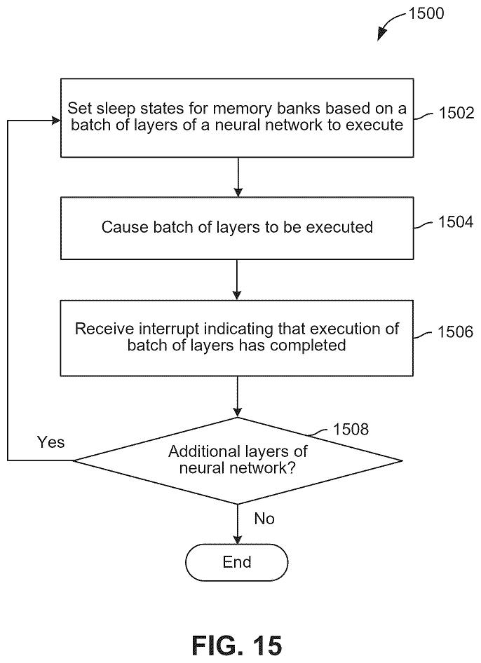

In some embodiments in which the source code includes code for executing a neural network, the compiler 103 can parse a graph of the neural network to determine the computation performed in and the precision required by each layer, as well as the component that performs the computation. Then, the compiler 103 can translate the computation, the precision, and the component that performs the computation into an appropriate memory allocation strategy by pattern matching to predefined rules. Notably, the memory allocation strategy, and the bank cluster size in particular, that is used for each layer can be different and set dynamically at runtime. Thereafter, the compiled machine code can be executed according to the method 1500, discussed below in conjunction with FIG. 15.

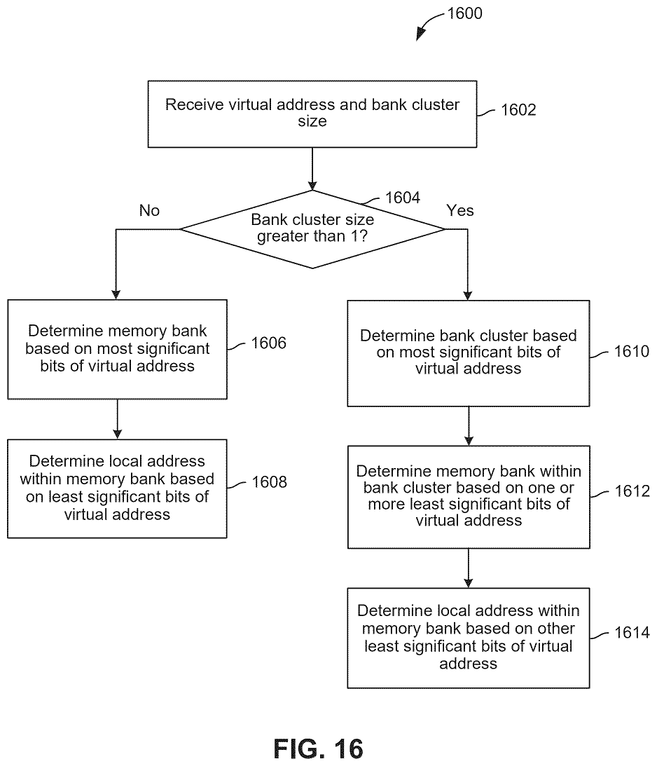

In some embodiments, the machine code can include read and write requests to the global scratchpad 416 that each specify a virtual address and a memory bank cluster size. Any suitable memory allocation strategies and memory bank cluster sizes can be used in some embodiments. Examples of memory allocation strategies and bank cluster sizes for various computations relating to neural networks are described above in conjunction with FIGS. 7-13. After the source code is compiled into machine code, the global scratchpad 416 can translate the virtual addresses to physical addresses according to the steps of method 1600, discussed below in conjunction with FIG. 16, and then read from or write to the physical addresses.

FIG. 15 is a flow diagram of method steps for executing a neural network using the system-on-chip of FIG. 4, according to various embodiments. Although the method steps are described in conjunction with FIGS. 1-5, persons skilled in the art will understand that any system configured to perform the method steps, in any order, falls within the scope of the present disclosure.

As shown, a method 1500 begins at step 1502, where the control processor 402 sets the sleep states for memory banks in the global scratchpad 416 based on a batch of layers of a neural network to execute. As described, the control processor 402 can issue commands to the global scratchpad 416 and the weight memory 418 to switch the states of memory banks therein. In some embodiments, the control processor 402 activates only the memory bank(s) storing data that is required to execute the batch of layers of the neural network, thereby switching such memory bank(s) to an “active state,” while maintaining the remaining memory bank(s) in other states that consume less leakage power, such as a “retention” state for memory banks storing data that needs to be used in the future and/or an “idle” state for memory banks that do not store any data related to the neural network. In such cases, the control processor 402 can activate only the memory bank(s) within the memory bank(s) in bank cluster(s) used to store data for executing the batch of layers, i.e., the memory bank(s) can be activated based on the bank cluster sizes associated with the read and write requests used to execute layers of the neural network in the batch of layers. Other memory bank(s) are not within such memory bank cluster(s) can be switched to the “retention” or “idle” states. Together with the clustering of memory banks, the individualized sleep control of memory banks permits a maximum bandwidth to be achieved while reducing the leakage power.

At step 1504, the control processor 402 causes the batch of layers to be executed. As described, when the batch of layers are to be executed by the AI accelerator 406, the control processor 402 can write, to the configuration memory 506, instructions for the AI accelerator 406 to execute the batch of layers and then return control to the control processor 402. Then, the control logic 504 can read the instructions from the configuration memory 506 and cause the layers to be executed sequentially. Execution of each layer can include (1) streaming weights of the layer and input activations from the weight memory 418 and the global scratchpad 416, respectively, into the AI accelerator 406; (2) the padding units 510 and 508 adding any necessary padding to the input activations and the weights, respectively, after which the results are stored in the input activation collector 514 and the weight collector 512, respectively; (3) the vector MAC units 516 performing multiply-accumulate operations using the stored input activations and weights with (optional) padding that are stored in the input activation collector 514 and the weight collector 512, respectively, to generate intermediate results; (4) the accumulation collector 518 gathering the intermediate calculation results from the vector MAC units 516 and accumulating the intermediate results together; (5) the PPU 520 performing post processing on the accumulated output of the accumulation collector 518; and (5) output of the PPU 512 being written back to the global scratchpad 416 as output activations. When the batch of layers is to be executed by the near-memory processor 410, the control processor 402 can similarly configure the near-memory processor 410 to execute the batch of layers sequentially. Read and write requests to the global scratchpad 416 include a virtual address and a bank cluster size that the global scratchpad 416 translates to physical addresses before performing the reads and writes at the physical addresses, as discussed in greater detail below in conjunction with FIG. 16.

At step 1506, the control processor 402 receives an interrupt from the AI accelerator 406 or the near-memory processor 410 indicating that execution of the batch of layers has completed. At step 1508, if there are no additional layers of the neural network, then the method 1500 ends. On the other hand, if there are additional layers of the neural network, then the method 1500 returns to step 1502, where the control processor 402 sets the sleep states for memory banks in the global scratchpad 416 based on a next batch of layers of a neural network to execute.

FIG. 16 is a flow diagram of method steps for translating virtual addresses to physical addresses using memory bank clusters, according to various embodiments. Although the method steps are described in conjunction with FIGS. 1-5, persons skilled in the art will understand that any system configured to perform the method steps, in any order, falls within the scope of the present disclosure.

As shown, a method 1600 begins at step 1602, where the global scratchpad 416 receives a virtual address and a bank cluster size. In some embodiments, the virtual address and bank cluster size can be included in a read or write request from the AI accelerator 406 or the near-memory processor 410. In such cases, the global scratchpad 416 can translate the virtual address to a physical address prior to reading from or writing to the physical address in a memory of the global scratchpad 416. Although the method 1600 is described with respect to the global scratchpad 416 as a reference example, in some embodiments, logic for an FSM at an input of the weight memory 418 (or other memory), or that is distinct from the weight memory 418 (or other memory), can perform similar steps to translate virtual addresses in read and write requests to physical addresses.

At step 1604, if the bank cluster size is not greater than 1 (i.e., the bank cluster size is equal to 1), then the method 1600 continues to step 1606, where the global scratchpad 416 determines a memory bank based on the most significant bits of the virtual address. Then, at step 1608, the global scratchpad 416 determines a local address within the memory bank based on the least significant bits of the virtual address, which are the other bits of the virtual address after the most significant bits.

On the other hand, if the bank cluster size is greater than 1 at step 1604, then the method 1600 proceeds directly to step 1610, where the global scratchpad 416 determines a bank cluster based on the most significant bits of the virtual address.

At step 1612, the global scratchpad 416 determines a memory bank within the bank cluster determined at step 1610 based on one or more least significant bits of the virtual address. For example, if the bank cluster size is 2, then one least significant bit could be used to determine the memory bank within the bank cluster; if the bank cluster size is four, then two least significant bits could be used to determine the memory bank within the bank cluster; etc.

Then, at step 1614, the global scratchpad 416 determines a local address within the memory bank determined at step 1610 based on other least significant bits of the virtual address.

In sum, techniques for dynamically configuring memory are disclosed. In some embodiments, a scratchpad memory associated with an AI accelerator can be dynamically configured to allocate memory according to memory bank cluster sizes specified in read and write requests. Memory allocations are interleaved within each bank cluster and are sequential across bank clusters. A read or write request to the scratchpad memory can include a virtual address and a bank cluster size. If the bank cluster size is equal to 1, then the scratchpad memory converts the virtual address to a physical address by (1) determining a memory bank based on the most significant bits of the virtual address, and (2) determining a local address within the memory bank based on the least significant bits of the virtual address. If the bank cluster size is greater than 1, then the scratchpad memory converts the virtual address to a physical address by (1) determining a bank cluster based on the most significant bits of the virtual address, (2) determining a memory bank within the bank cluster based on one or more least significant bits of the virtual address, and (3) determining a local address within the memory bank based on the other least significant bits of the virtual address. The scratchpad memory then reads or writes to the converted physical address. In some embodiments, activations that are input into, or output by, layers of a neural network can be written to and read from the scratchpad memory using various bank cluster sizes that are determined by a compiler based on computations performed by the layers, what component executes the computations, and/or the required precision.

One technical advantage of the disclosed techniques relative to the prior art is that, with the disclosed techniques, data can be stored across memory bank clusters that include multiple, but not all, of the memory banks of a memory system. Storing data across multiple memory banks in this fashion permits data to be stored and retrieved from the different memory banks within the memory bank cluster simultaneously, which can increase overall data transfer rates. In addition, with the disclosed techniques, any memory banks that are not being used to store data can be switched to a reduced power state, which can reduce overall power consumption of the memory system, including both idle power consumption and leakage power consumption. These technical advantages provide one or more technological improvements over prior art approaches.
1. In some embodiments, a computer-implemented method for storing and accessing data comprises receiving a request that specifies a first memory address and a memory bank cluster size, and storing data in or reading data from a memory bank included in a memory based on the first memory address and the memory bank cluster size.
2. The computer-implemented method of clause 1, wherein storing the data in or reading the data from the memory bank comprises converting the first memory address to a second memory address, identifying the memory bank based on the first memory address and the memory bank cluster size, and storing the data in or reading the data from the memory bank at the second memory address.
3. The computer-implemented method of clauses 1 or 2, wherein the first memory address is converted to the second memory address based on one or more least significant bits included in the first memory address.
4. The computer-implemented method of any of clauses 1-3, wherein the memory bank is identified based on at least one of one or more most significant bits or one or more least significant bits included in the first memory address.
5. The computer-implemented method of any of clauses 1-4, wherein identifying the memory bank comprises identifying a memory bank cluster based on one or more first bits included in the first memory address, and identifying the memory bank within the memory bank cluster based on one or more second bits included in the first memory address.
6. The computer-implemented method of any of clauses 1-5, wherein the memory bank is in an active state, and further comprising switching at least one other memory bank included in the memory to an idle state or a retention state.
7. The computer-implemented method of any of clauses 1-6, wherein the memory bank cluster size is equal to one, and the data is stored sequentially with other data within the memory bank.
8. The computer-implemented method of any of clauses 1-7, wherein the memory bank cluster size is greater than one, and storing the data comprises interleaving the data with other data across a plurality of memory banks included in the memory.
9. The computer-implemented method of any of clauses 1-8, wherein the data includes a value for at least one of a weight from a layer included in a neural network, an input into the layer, or an output of the layer.
10.The computer-implemented method of any of clauses 1-9, further comprising compiling source code associated with the request into machine code based on at least one of a computation included in the source code, a processor that executes the computation, or a precision required by the computation, wherein the machine code includes the request.
11.In some embodiments, a processor comprises a memory that comprises a plurality of memory banks, and circuitry configured to receive a request that specifies a first memory address and a memory bank cluster size, and store data in or read data from a first memory bank included in the plurality of memory banks based on the first memory address and the memory bank cluster size.
12.The processor of clause 11, wherein the first memory address comprises a virtual memory address, and storing the data in or reading the data from the at least one memory banks comprises converting the first memory address to a second memory address, wherein the second memory address comprises a physical memory address, identifying the first memory bank based on the first memory address and the memory bank cluster size, and storing the data in or reading the data from the first memory bank at the second memory address.
13.The processor of clauses 11 or 12, wherein the first memory address is converted to the second memory address based on one or more least significant bits included in the first memory address.
14.The processor of any of clauses 11-13, wherein the memory bank is identified based on at least one of one or more most significant bits or one or more least significant bits included in the first memory address.
15.The processor of any of clauses 11-14, wherein identifying the first memory bank comprises identifying a memory bank cluster based on one or more first bits included in the first memory address, and identifying the first memory bank within the memory bank cluster based on one or more second bits included in the first memory address.
16.The processor of any of clauses 11-15, wherein the memory bank cluster size is equal to one, and the data is stored sequentially with other data within the first memory bank.
17.The processor of any of clauses 11-16, wherein the memory bank cluster size is greater than one, and storing the data comprises interleaving the data with other data across a subset of memory banks included in the plurality of memory banks.
18.The processor of any of clauses 11-17, wherein the memory comprises a scratchpad memory.
19.The processor of any of clauses 11-18, wherein the processor comprises a graphics processing unit (GPU).
20.In some embodiments, a system comprises a memory that comprises a plurality of memory banks, and a processor that is coupled to the memory and configured to perform the steps of receiving a request that specifies a first memory address and a memory bank cluster size, and storing data in or reading data from a first memory bank included in the plurality of memory banks based on the first memory address and the memory bank cluster size.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for storing and accessing data, the method comprising:
receiving a request that specifies a first memory address and a memory bank cluster size; and
storing data in or reading data from a memory bank included in a memory based on the first memory address and the memory bank cluster size.

2. The computer-implemented method of claim 1, wherein storing the data in or reading the data from the memory bank comprises:
converting the first memory address to a second memory address;
identifying the memory bank based on the first memory address and the memory bank cluster size; and
storing the data in or reading the data from the memory bank at the second memory address.

3. The computer-implemented method of claim 2, wherein the first memory address is converted to the second memory address based on one or more least significant bits included in the first memory address.

4. The computer-implemented method of claim 2, wherein the memory bank is identified based on at least one of one or more most significant bits or one or more least significant bits included in the first memory address.

5. The computer-implemented method of claim 2, wherein identifying the memory bank comprises:
identifying a memory bank cluster based on one or more first bits included in the first memory address; and
identifying the memory bank within the memory bank cluster based on one or more second bits included in the first memory address.

6. The computer-implemented method of claim 2, wherein the memory bank is in an active state, and further comprising switching at least one other memory bank included in the memory to an idle state or a retention state.

7. The computer-implemented method of claim 1, wherein the memory bank cluster size is equal to one, and the data is stored sequentially with other data within the memory bank.

8. The computer-implemented method of claim 1, wherein the memory bank cluster size is greater than one, and storing the data comprises interleaving the data with other data across a plurality of memory banks included in the memory.

9. The computer-implemented method of claim 1, wherein the data includes a value for at least one of a weight from a layer included in a neural network, an input into the layer, or an output of the layer.

10. The computer-implemented method of claim 1, further comprising compiling source code associated with the request into machine code based on at least one of a computation included in the source code, a processor that executes the computation, or a precision required by the computation, wherein the machine code includes the request.

11. A processor comprising:
a memory that comprises a plurality of memory banks; and
circuitry configured to:
receive a request that specifies a first memory address and a memory bank cluster size, and
store data in or read data from a first memory bank included in the plurality of memory banks based on the first memory address and the memory bank cluster size.

12. The processor of claim 11, wherein the first memory address comprises a virtual memory address, and storing the data in or reading the data from the at least one memory banks comprises:
converting the first memory address to a second memory address, wherein the second memory address comprises a physical memory address;
identifying the first memory bank based on the first memory address and the memory bank cluster size; and
storing the data in or reading the data from the first memory bank at the second memory address.

13. The processor of claim 12, wherein the first memory address is converted to the second memory address based on one or more least significant bits included in the first memory address.

14. The processor of claim 12, wherein the memory bank is identified based on at least one of one or more most significant bits or one or more least significant bits included in the first memory address.

15. The processor of claim 12, wherein identifying the first memory bank comprises:
identifying a memory bank cluster based on one or more first bits included in the first memory address; and
identifying the first memory bank within the memory bank cluster based on one or more second bits included in the first memory address.

16. The processor of claim 11, wherein the memory bank cluster size is equal to one, and the data is stored sequentially with other data within the first memory bank.

17. The processor of claim 11, wherein the memory bank cluster size is greater than one, and storing the data comprises interleaving the data with other data across a subset of memory banks included in the plurality of memory banks.

18. The processor of claim 11, wherein the memory comprises a scratchpad memory.

19. The processor of claim 11, wherein the processor comprises a graphics processing unit (GPU).

20. A system, comprising:
a memory that comprises a plurality of memory banks; and
a processor that is coupled to the memory and configured to perform the steps of:
receiving a request that specifies a first memory address and a memory bank cluster size, and
storing data in or reading data from a first memory bank included in the plurality of memory banks based on the first memory address and the memory bank cluster size.
